(19) United States
(12) Patent Application Publication
(10) Pub. No.: US 2011/0240410 A1
(43) Pub. Date: Oct. 6, 2011

(54) ELEVATOR BRAKE ACTUATOR HAVING A SHAPE-CHANGING MATERIAL FOR BRAKE CONTROL

(76) Inventors: Rodolfo Robledo Barrio, Berlin (DE); Gianfranco Giannini, Berlin (DE); Jurgen Gewinner, Berlin (DE); Zbigniew Piech, Cheshire, CT (US); James Hubbard, Kensington, CT (US); Muhammad Jehanzeb Noor, East Lansing, MI (US)

(21) Appl. No.: 11/815,674

(22) PCT Filed: Feb. 25, 2005
(86) PCT No.: PCT/US05/06264

§ 371 Date: Apr. 11, 2011

(51) Int. Cl. B66B 1/32; F16D 65/21

(52) U.S. Cl. 187/288; 188/171

(57) ABSTRACT

An elevator machine (10) includes a motor (12) that rotationally drives a machine shaft (14). An elevator machine brake (20) applies braking force to a disk (22) that is coupled to the machine shaft (14) to slow or stop the rotation of the machine shaft (14). In one example, the elevator machine brake (20) includes a bias member (38) that applies a bias force to a caliper arrangement (32) to provide a braking force on the disk (22). A brake actuator (48) having a shape-changing material moves against the bias force to control engagement between the caliper arrangement (32) and the disk (22). A controller (26) selectively varies the braking force applied to the disk (22) by controlling an electric input to the shape-changing material of the brake actuator (48).

### FIELD OF THE INVENTION

This invention generally relates to elevator brakes and, more particularly to elevator machine brakes including a piezoelectric brake actuator.

### BACKGROUND OF THE INVENTION

Elevator systems are widely known and used. Typical arrangements include an elevator cab that moves between landings in a building, for example, to transport passengers or cargo to different levels in the building. A motorized elevator machine moves a rope or a belt, which typically supports the weight of the cab so that it moves through a hoistway.

The elevator machine includes a machine shaft rotationally driven by the machine motor. A sheave is supported on the machine shaft and rotates with the machine shaft. The ropes or belts are typically tracked through the sheave such that the machine motor may rotate the sheave in one direction to lower the cab and rotate the sheave in the opposite direction to raise the cab. The elevator machine typically includes a solenoid-actuated brake that engages a disk or flange that rotates with the machine shaft to hold the machine shaft and sheave when the cab is at a selected landing.

Operationally, the solenoid-actuated brake may be switched on or off to respectively engage or disengage the disk or flange associated with the machine shaft. Switching the solenoid-actuated brake on and off often produces undesirable noise as the brake contacts the disk or flange to apply a braking force. Additionally, solenoid-actuated brakes may be considerably bulky and expensive, may produce excessive heat, and may require additional auxiliary parts to achieve a desired level of operation. One example auxiliary part is a proximity sensor to determine a position of the brake. Such parts add to the expense and maintenance of known solenoid-actuated brakes.

There is a need for a quieter, simplified and compact elevator machine brake. This invention addresses those needs and provides enhanced capabilities while avoiding the shortcomings and drawbacks of the prior art.

### SUMMARY OF THE INVENTION

An exemplary braking device useful in an elevator system selectively varies the braking force applied to a rotating portion of the elevator machine by controlling an influence on a shape-changing material of a brake actuator that controls engagement between a brake member and the rotating portion.

One example elevator machine includes a motor that rotationally drives a machine shaft. An elevator machine brake applies a braking force to a disk, which is coupled to the machine shaft, to control movement of an elevator car as it slows or stops rotation of the machine shaft. One example elevator machine brake includes a bias member that applies a bias force to cause engagement between a braking member and the disk. The brake actuator operates against the bias force to allow selective movement of the disk and shaft.

In one example, the brake actuator moves between a plurality of different braking positions. A controller determines the plurality of different braking positions and controls an input to the brake actuator.

In another example, the position of the brake actuator is determined based upon at least one of the influence on the brake actuator or an electric output from the brake actuator. The controller uses the electric input, a detected piezoelectric stack voltage or both, for example, to determine the position of the brake actuator and thus the position of a braking member relative to the rotating portion.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 is a cross-sectional view of an example elevator machine.

FIG. 2 is a schematic, partial cross-sectional view of selected portions of the elevator brake portion of the elevator machine of FIG. 1 in one operating condition.

FIG. 3 is a schematic, partial cross-sectional view similar to FIG. 2 but showing another operating condition.

FIG. 4 is a schematic, partial cross-sectional view of selected portions of another example elevator brake.

FIG. 5 is a schematic, partial cross-sectional view of selected portions of another embodiment of an example elevator brake.

### DETAILED DESCRIPTION OF THE PREFERRED EMBODIMENTS

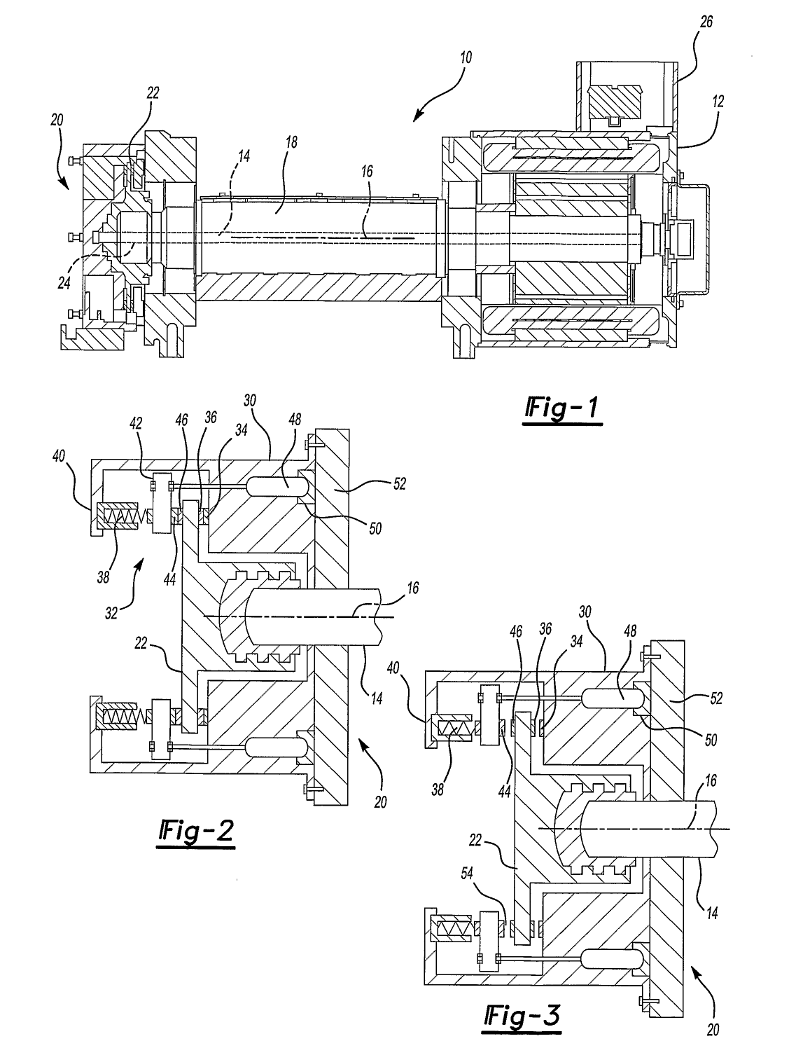

FIG. 1 illustrates in cross-sectional view, an example elevator machine 10 including a motor 12 that rotationally drives a machine shaft 14 about an axis 16. A sheave 18 rotates with the machine shaft 14 about the axis 16. An elevator machine brake 20 selectively applies a braking force to a disk 22 that is coupled to an end portion 24 of the machine shaft 14 to slow or stop the rotation of the machine shaft 14. As known, such a machine (i.e., a motor and a brake) control the position or movement of an elevator car in a hoistway.

A controller 26 operates the motor 12 and the elevator machine brake 20. The controller 26 may be integrated with the elevator machine 10 or may be located remotely from the elevator machine 10. In one example, the controller 26 selectively controls power to the motor 12 and selectively varies the braking force that the elevator machine brake 20 applies to the disk 22.

FIG. 2 shows one example elevator brake 20. This example includes a housing 30 that supports a generally known caliper arrangement 32. The example elevator brake 20 includes a brake pad 34 that frictionally engages a first braking surface 36 on the disk 22 to apply a braking force to the disk 22. The caliper arrangement 32 includes a bias member 38 such as a spring mounted in a rigid caliper arm 40. The bias member 38 is coupled to a linkage 42. The linkage 42 includes a caliper brake pad 44 that frictionally engages a second braking surface 46 on the disk 22.

The linkage 42 is operatively associated with a brake actuator 48 that is at least partially supported by an actuator housing 50. The actuator housing 50 is mounted on a rigid portion of the brake or machine assembly 52.

The bias member 38 applies a bias force to the linkage 42 that urges the caliper brake pad 44 towards the second braking surface 46 and the disk 22 toward the brake pad 34 to provide a braking force on both sides of the disk 22. A fully applied braking position is illustrated in FIG. 2.

In one example, an applied influence such as an electric field, electric current, a voltage or a magnetic field, for example, controls the brake actuator 48 to move the linkage 42 against the bias force to reduce or eliminate the braking force on the disk 22, as illustrated in FIG. 3. The bias force normally applies a braking force to the disk 22. Controlling the influence on the brake actuator 48 controls the amount of movement of the linkage 42 and, therefore, the magnitude of the braking force.

The illustrated brake actuator 48 comprises a known shape-changing material that changes shape in response to the selected influence. The shape change is not necessarily a change in geometrical shape. Rather, the crystal or molecular structure of the material changes shape responsive to the applied influence in a known manner. Such a shape change often results in an elongation or contraction of the material within the actuator 48.

In one example, the material of the brake actuator 48 changes shape by expanding in response to the applied influence to move the linkage 42 against the bias force to reduce or eliminate the braking force on the disk 22. When the influence is removed, the material contracts and the bias force applies the braking force to the disk 22.

In another example, the material expands to apply the braking force.

In one example, the shape-changing material of the brake actuator 48 includes a known piezoelectric material. As known, piezoelectric material changes shape in response to an electrical input, such as an electric current or a voltage. The change in the shape is proportional to the magnitude of the electrical input and the change may be positive or negative (i.e., expanding in a nominal direction or contracting in the nominal direction) depending on the polarity of the electrical input, for example.

In another example, the shape-changing material of the brake actuator 48 includes a known magnetostrictive material. As known, magnetostrictive material changes shape in response to a magnetic field. The change in shape typically is proportional to the magnitude of the magnetic field. The shape change may be positive or negative (i.e., expanding in a nominal direction or contracting in the nominal direction) depending on the orientation of the magnetic field, for example.

Other examples include an electrorestrictive material that changes responsive to an electrical influence in a controllable or periodic manner. A variety of such materials are known.

One feature of the example brake actuator 48 that is advantageous is the relatively small size of the brake actuator 48 compared to solenoid actuators. The small size of the brake actuator 48 reduces the amount of design space required in the elevator brake 20, consumes less energy, and provides a longer usage life. Moreover, the light weight of the brake actuator 48 reduces the overall weight of the elevator brake 20 compared to previously known elevator brakes.

An actuator having a shape-changing material has advantages compared to solenoid actuators used in known elevator machine brakes. For example, the actuator 48 having a shape-changing material is selectively and precisely controllable to precisely control the magnitude of a braking force. This allows for avoiding the noises associated with known arrangements where the brake pads were either fully applied or fully released with no gradual control of movement between those positions. It is known that the amount of influence (i.e., electrical current) provided to the shape-changing material, for example a piezoelectric stack, changes the size of the stack (i.e., causes expansion or contraction). In the example of FIGS. 2 and 3, the controller 26 precisely controls the braking forces by precisely controlling the influence on the actuator 48.

In one example, the brake actuator 48 moves the linkage 42 between a plurality of different braking positions. The plurality of different braking positions result from different influences on the brake actuator 48. In one example, the controller 26 determines a required initial braking force in a braking application and activates the brake actuator 48 with a corresponding influence on the brake actuator 48 to generate the required braking force on the disk 22. If the initial braking force is not adequate to slow or stop the rotating machine shaft 14 as the car approaches its destination, the controller determines a second, greater braking force and changes the influence to generate the greater braking force. Such gradual brake application reduces noise and enhances passenger comfort and ride quality such gradual brake application was not possible with previous, known actuators.

In another example, the controller 26 selectively varies the braking force to gradually increase or decrease the braking force applied to the disk 22. Selectively varying the braking force may advantageously reduce noise in the elevator machine brake 20 and allow smoother movement of an elevator cab.

Compared to prior art elevator machine brakes, utilizing the example brake actuator 48 may allow reducing a gap 54 between the brake pads 36, 46 and the braking surfaces on the disk 22, thereby further reducing any “clamping” noise that otherwise occurs upon engagement between the brake pads 34, 44 and the disk 22.

In other examples, the controller 26 selectively varies the braking force in response to an emergency situation. Emergency situations may occur when an elevator cab is in free fall, for example. A selected influence on the brake actuator 48 moves the linkage 42 in the direction of the bias force to supplement the bias force and provides a gradually applied additional emergency braking force on the disk 22 in a free fall situation. This type of control enhances passenger comfort as known emergency stopping devices are not capable of gradual brake force application but the illustrated actuators 48 are.

Positively or negatively energizing the brake actuator 48 may also be utilized to move the linkage 42 in a manner to release it from a stuck, engaged or disengaged position, for example. For example, a positive voltage may be used during brake applications. If the brake is stuck in an applied position, a negative voltage can be applied to cause a reverse response by the shape-changing material to release the brake components. Using the actuators 48 in this manner can reduce a need for manual maintenance procedures.

Another feature of the disclosed examples is that the actuators 48 provide position information regarding the brake components. This eliminates the need for additional position sensors.

The condition of the brake actuator 48, and thus the position of the linkage 42 and the brake pads relative to the disk 22, is determined in one example based upon at least one of the selected influence on the brake actuator 48 or a measurable output from the brake actuator 48. In one example, the brake actuator 48 includes a piezoelectric material and the controller 26 uses the electric influence or an electric output such as a voltage level from the piezoelectric material to determine the position of the linkage 42 relative to the disk 22. That is, predetermined input or output values correspond to predetermined piezoelectric material conditions and corresponding brake positions such that for a given input or output, the brake actuator 48 position can be determined. Given this description, those skilled in the art will realize how to use such information to make position determinations for their particular brake arrangement.

In other examples, the controller 26 uses a piezoelectric actuator voltage output to monitor and correct for brake pad wear. The piezoelectric actuator voltage outputs correspond to predetermined positions for applying a braking force such that the controller 26 detects brake pad wear when the actual position for a given input is different than an expected position (as determined from the output voltage). In one example, when the controller 26 detects a different than expected actual position (i.e., brake pad wear), the controller 26 automatically adjusts control parameters to provide desired braking, provides a service indication regarding the detected brake pad wear, or both.

In other examples, the controller 26 uses the position information to detect whether the shape-changing material of the brake actuator 48 is effective for applying a braking force and to ensure that the motor 12 is not driving through the applied braking force.

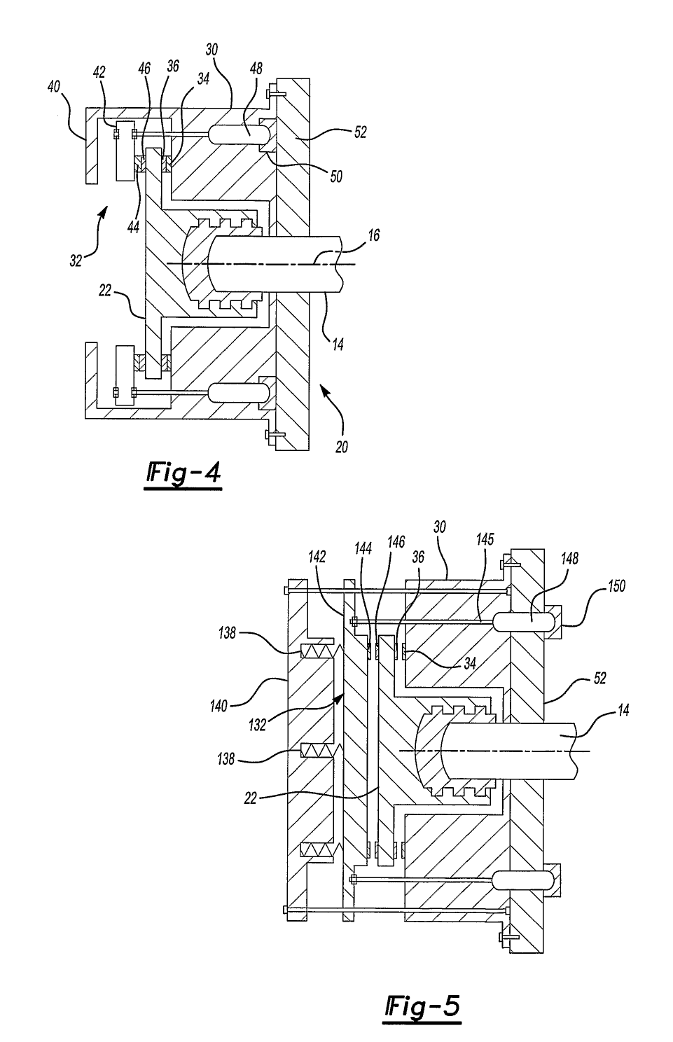

FIG. 4 illustrates another embodiment of an elevator brake including a disk braking member 132. Bias members 138 are mounted in a rigid bias plate 140. The bias members 138 urge a brake disk 142, which includes a brake pad 144, to apply a braking force to the disk 22. A linkage 145 is associated with brake actuators 148, which operate much the same as the brake actuators 48 to selectively apply a braking force to the disk 22. The brake actuators 148 in this example move the disk braking member 132 against a bias force of the bias members 138.

FIG. 5 illustrates another example elevator brake 20 without a bias member 38. The controller 26 in this example selectively influences the shape-changing material of the brake actuator 48 to disengage the brake pads 34, 44 from the disk 22. When the influence on shape-changing material is removed, for example when the controller selects not to energize or during an electrical power failure, the brake pads 34, 44 engage the disk 22 to provide a braking force. Thus, the controller 26 may exclusively use the brake actuators 48 to control the braking force without requiring a separate bias member such as a mechanical spring. Alternatively, the controller 26 may selectively influence the shape-changing material to contract the material to provide the braking force on the disk 22. In examples that utilize known stacks of shape-changing materials, the strength between stacked layers is sufficient to withstand the cyclic application and removal of the braking forces.

One feature of the example elevator brake 20 without the bias member 38 that may provide an advantage is the added size advantage. Without the bias member 38, the rigid caliper arm 40 is reduced in size (i.e., the rigid caliper arm 40 is moved closer to the disk 22). The compact size of the piezoelectric brake actuator 48 may reduce the amount of design space required in the elevator brake 20. Additionally, the lighter weight without the bias member 38 and associated structural support components may reduce the overall weight and cost of the elevator brake 20 compared to previously known elevator brakes.

Although a preferred embodiment of this invention has been disclosed, a worker of ordinary skill in this art would recognize that certain modifications would come within the scope of this invention. For that reason, the following claims should be studied to determine the true scope and content of this invention.

1. A method of controlling an elevator machine brake having a braking member that engages an elevator machine rotating portion comprising:
selectively controlling a braking force applied by the braking member by controlling an influence on a brake actuator material that changes shape in response to the influence for controlling engagement between the braking member and the elevator machine rotating portion.

2. The method as recited in claim 1, comprising applying at least one of an electrical or a magnetic influence to the shape-changing material.

3. The method as recited in claim 1, comprising varying a magnitude of the influence to move the braking member to a corresponding plurality of different braking positions.

4. The method as recited in claim 1, wherein the material comprises at least one of a piezoelectric, magnetostrictive, or electrostrictive material.

5. The method as recited in claim 1, wherein the braking member is biased to engage the rotating portion and comprising selectively influencing the material to change the shape of the material to act against the bias.

6. The method as recited in claim 1, comprising determining a position of the braking member relative to the rotating portion based upon at least one of a magnitude of the influence or output from the material.

7. The method as recited in claim 6, comprising using an electric current associated with the influence for determining the position of the braking member relative to the rotating portion.

8. The method as recited in claim 6, comprising using an electric voltage associated with the output from the material for determining the position of the braking member relative to the rotating portion.

9. A method of controlling an elevator machine brake having a brake actuator material that changes shape responsive to a selected influence to control engagement between a braking member and a rotating portion that rotates in response to the elevator machine comprising:
determining a position of the braking member relative to the rotating portion based upon at least one of the influence or an output from the brake actuator material.

10. The method as recited in claim 9, comprising using an electric current associated with the influence to the material for determining the position of the braking member relative to the rotating portion.

11. The method as recited in claim 9, comprising using an electric voltage associated with the output from the material for determining the position of the braking member relative to the rotating portion.

12. The method as recited in claim 9, comprising selectively varying a braking force applied by the braking member during a braking application by controlling the influence on the material for controlling engagement between the brake member and the rotating portion.

13. The method as recited in claim 9, wherein material comprises at least one of a piezoelectric, magnetostrictive, or electrostrictive material.

14. A device for use in an elevator assembly comprising:
an elevator brake actuator including a material that changes shape in response to a selected influence to control a braking force on an elevator machine rotatable portion.

15. The device of claim 14, wherein the shape change includes at least one of an expansion of said material to alter the braking force in a first direction and a retraction of said material to alter the braking force in an opposite direction.

16. The device of claim 14, wherein said material includes at least one of a piezoelectric, electrostrictive, or a magnetostrictive material.

17. The device of claim 14, wherein said brake actuator is moveable between a plurality of applied braking positions corresponding to a plurality of applied braking forces.

18. The device of claim 14, wherein said brake actuator moves a braking member that engages the elevator machine rotatable portion and said material controls a position of said braking member.

19. The device of claim 14, comprising a controller in communication with said brake actuator for controlling said influence.

20. The device of claim 19, wherein said controller determines a position of a braking member that is moveable to resist rotation of the elevator machine rotatable portion based on said influence.

21. The device of claim 19, wherein the controller determines a position of a braking member that is moveable to resist rotation of the elevator machine rotatable portion based on an electrical output from the material.

22. The device of claim 14, wherein the influence comprises at least one of an electric current, an electric field, a voltage or a magnetic field.
